(19) United States
(12) Patent Application Publication
(10) Pub. No.: US 2005/0069261 A1
(43) Pub. Date: Mar. 31, 2005

(54) Optical semiconductor device and method of manufacturing same

(75) Inventor: Tatsuro Arayama, Kawasaki-Shi (JP)

Correspondence Address: YOUNG & THOMPSON, 745 SOUTH 23RD STREET, 2ND FLOOR, ARLINGTON, VA, 22202, US

(73) Assignee: NEC COMPOUND SEMICONDUCTOR DEVICES, LTD, KAWASAKI-SHI (JP)

(21) Appl. No.: 10/951,603

(22) Filed: Sep. 29, 2004

(30) Foreign Application Priority Data
Sep. 29, 2003 (JP) 2003-338915

(51) Int. Cl. G02B 6/26; G02B 6/42

(52) U.S. Cl. 385/52

(57) ABSTRACT

An optical semiconductor device includes a substrate and a plurality of optical parts mounted thereon. Guide grooves are formed in the substrate at the mounting positions of the optical parts. Each guide groove has first side surfaces, which are substantially orthogonal to the direction of the optical axis, second side surfaces, which are substantially parallel to the direction of the optical axis and substantially perpendicular to the surface of the substrate, and a bottom surface substantially parallel to the surface of the substrate. Each guide groove has a size and a depth that allow at least a bottom portion of the corresponding optical part to be received therein. The corresponding optical part is accommodated in each guide groove in abutting contact with the first side surfaces of the guide groove, whereby the optical parts are aligned with one another along the direction of the optical axis.

### FIELD OF THE INVENTION

This invention relates to an optical semiconductor device and method of manufacturing the same. More particularly, the invention relates to an optical semiconductor device in which a plurality of optical parts are mounted on a substrate and optically coupled, and to a method of manufacturing this device.

### BACKGROUND OF THE INVENTION

An optical semiconductor device of the kind shown in FIGS. 3A and 3B is an example of an optical semiconductor device according to the prior art. FIG. 3A is a plan view illustrating this optical semiconductor device according to the prior art, and FIG. 3B is a sectional view taken along optical axis 6 in FIG. 3A.

This optical semiconductor device includes a substrate 1 and a semiconductor laser chip 2, optical lens 3 and optical fiber 4 placed on the substrate 1 along the optical axis 6 in the order mentioned starting from the side of the semiconductor laser chip 2. These optical parts are aligned with one another in terms of an optical axis and the parts are optically coupled. In this case, the semiconductor laser chip 2 and optical lens 3 are mounted on the same substrate and the optical fiber, which is a separate optical part, is placed externally of the substrate 1 and is optically coupled to the optical lens 3 on the substrate 1.

An alignment pattern 5 is formed on the surface of the substrate 1, and the optical parts 2, 3, 4 have their optical axes adjusted along the optical-axis direction and horizontal direction by a mounting apparatus based upon the alignment pattern 5.

In general, it is important from the standpoint of optical coupling that the optical parts used in an optical semiconductor device be precisely positioned relative to one another. In particular, a positioning accuracy on the micron order is required between the semiconductor laser chip (semiconductor light-source chip) 2 and the optical lens 3.

With a structure in which optical parts are mounted on a planar substrate in the prior art, mounting is achieved by recognizing the alignment pattern 5 and aligning the optical axes of the optical parts by a mounting apparatus. This means that the alignment accuracy of the optical parts depends upon the aligning capability of the mounting apparatus. Accordingly, in order to attain the alignment accuracy desired for optical parts, it is necessary to use a mounting apparatus having a high alignment accuracy. Generally, a mounting apparatus having a high alignment accuracy is very expensive and introduction of such an apparatus necessitates costly capital investment. In addition, recognizing the alignment pattern 5 when mounting is performed takes time. This leads to an increase in assembly and working costs.

In an effort to effect an improvement, the specifications of Japanese Patent Kokai Publication Nos. 11-194240 and 2001-343560 (Patent Publications 1 and 2, respectively) describe an example in which a V-shaped groove is formed in a silicon substrate by photolithography and reactive ion etching, and a cylindrical optical fiber and spherical ball lens are mounted utilizing the inclined surfaces of the V-shaped groove, whereby the optical axes of these parts are adjusted relative to each other. Further, the specification of Japanese Patent Kokai Publication No. 06-140645 (Patent Reference 3) discloses an example in which an optical semiconductor module is produced using a packaged optical semiconductor element and optical lens, etc. In the example described in Patent Publication 3, the optical parts are mutually aligned by fitting the packaged optical semiconductor element and optical lens in holes.

[Patent Publication 1]
Japanese Patent Kokai Publication No. 11-194240

[Patent Publication 2]
Japanese Patent Kokai Publication No. 2001-343560

[Patent Publication 3]
Japanese Patent Kokai Publication No. 06-140645

### SUMMARY OF THE DISCLOSURE

In accordance with both Patent Publications 1 and 2, a semiconductor laser or light-emitting element is placed on the surface of a substrate and has its optical axis aligned with an optical fiber, which has been fitted into a groove, based upon an alignment pattern. In order to align the semiconductor laser and optical fiber, therefore, it is necessary to employ a mounting apparatus having a high alignment accuracy. Further, both references describe adjustment of the optical axes between the semiconductor laser and optical fiber. However, nowhere do these references describe adjustment of the optical axes between these parts in a case where an optical lens is interposed between them.

Further, in Patent Publication 3, the formation of the holes requires highly precise coaxial working. Since this necessitates highly sophisticated mold or cutting technology, it will be difficult to deal with situations in the future where an improvement in optical transmission efficiency and yield are required.

Accordingly, an object of the present invention is to provide an optical semiconductor device and a method of manufacturing the same, in which optical parts, particularly a semiconductor light-source chip and an optical lens, can be mutually aligned with high accuracy by simple working of the substrate on which the optical parts are mounted, without using a mounting apparatus having high alignment accuracy.

According to one aspect of the present invention, the foregoing object is attained by providing an optical semiconductor device comprising a substrate and a plurality of optical parts mounted on the substrate and optically coupled with their optical axes in alignment with one another. A plurality of guide grooves are formed in the substrate at mounting positions of respective ones of the plurality of optical parts, each guide groove has at least a first side surface substantially orthogonal to the direction of the optical axis, second side surfaces substantially parallel to the direction of the optical axis and substantially perpendicular to the surface of the substrate, and a bottom surface substantially parallel to the surface of the substrate, each guide groove having a size and a depth that allow at least a bottom portion of the corresponding optical part to be received therein. In each guide groove the corresponding optical part is accommodated in abutting contact with the first side surface of the guide groove, whereby the optical parts are aligned with one another along the direction of the optical axis.

In a preferred embodiment, each optical part is abutted against the second side surface, whereby the optical parts are aligned with one another along the direction substantially parallel to the surface of the substrate as well as along the direction of the optical axis.

In a preferred embodiment, the substrate is a silicon substrate with (110) surface orientation.

In a preferred embodiment, the optical parts are a semiconductor light-source chip and an optical lens in the shape of a rectangular parallelepiped.

According to a second aspect of the present invention, the foregoing object is attained by providing a method of manufacturing an optical semiconductor device having a substrate and a plurality of optical parts mounted on the substrate and optically coupled with their optical axes in alignment with one another. The method comprises the steps of: forming a plurality of guide grooves in the substrate at mounting positions of respective ones of the plurality of optical parts, each guide groove having at least a first side surface substantially orthogonal to the direction of the optical axis, second side surfaces substantially parallel to the direction of the optical axis and substantially perpendicular to the surface of the substrate, and a bottom surface substantially parallel to the surface of the substrate, each guide groove having a size and a depth that allow at least a bottom portion of the corresponding optical part to be received therein; and accommodating each optical part in a corresponding one of the guide grooves in abutting contact with the first side surface of the guide groove, whereby the optical parts are aligned with one another along the direction of the optical axis.

In a preferred embodiment, the method further comprises a step of abutting each optical part against the second side surfaces, whereby the optical parts are aligned with one another along the direction substantially parallel to the surface of the substrate as well as along the direction of the optical axis.

In a preferred embodiment, the substrate is a silicon substrate with (110) surface orientation.

In a preferred embodiment, the guide grooves are formed by etching the substrate chemically or physically or chemically and physically.

In a preferred embodiment, the optical parts are a semiconductor light-source chip and an optical lens in the shape of a rectangular parallelepiped.

The actions of the present invention obtained by the above-described structure will now be described.

In accordance with the structure of the optical semiconductor device of the present invention, a substrate on which optical parts are mounted has a plurality of guide grooves. Each guide groove has at least a first side surface (or surfaces), which are substantially orthogonal to the direction of the optical axis, second side surfaces, which are substantially parallel to the direction of the optical axis and substantially perpendicular to the surface of the substrate, and a bottom surface substantially parallel to the surface of the substrate. Each guide groove has a size and a depth that allow at least a bottom portion of the corresponding optical part to be received therein.

Accordingly, if the depths of the guide grooves are adjusted in advance in conformity with the corresponding optical parts, merely accommodating the optical parts, particularly a semiconductor light-source chip having the shape of a rectangular parallelepiped and an optical lens member having the shape of a rectangular parallelepiped, in the guide grooves will bring the bottom surfaces of the optical parts into abutting contact with the bottom surfaces of the guide grooves so that the optical axes of the parts can be aligned with each other in terms of the height direction.

Further, if at least either one of the two first side surfaces of each guide groove with which the corresponding optical part is abutted is adjusted in advance in such a manner that the distance between the optical parts along the optical axis is optimized, then the optical parts can be aligned with one another in the direction of the optical axis by bringing each optical part into abutting contact with this side surface of the corresponding guide groove. Furthermore, if at least either one of the two second side surfaces of each guide groove with which the corresponding optical part is abutted is adjusted in advance in such a manner that the optical axes of the optical parts will coincide in terms of the horizontal direction, then the optical parts can have their optical axes aligned with one another in terms of the horizontal direction by bringing each optical part into abutting contact with this side surface of the corresponding guide groove.

As a result, the optical axes of a semiconductor light-source chip and optical lens can be aligned with each other in simple fashion in all directions without using a mounting apparatus having a high alignment accuracy.

Further, in accordance with the implementation of the method of manufacturing an optical semiconductor device according to the present invention, guide grooves having the above-described shape are formed, and optical parts, particularly a semiconductor light-source chip having the shape of a rectangular parallelepiped and an optical lens member having the shape of a rectangular parallelepiped, are brought into abutting contact with the first faces of the corresponding (pair of) guide grooves, whereby the optical parts are aligned with one another in the direction of the optical axis.

In this case, if the depths of the guide grooves are adjusted in advance in conformity with the corresponding optical parts and the first side surfaces of each guide groove with which the corresponding optical part is contacted is adjusted in advance in such a manner that the distance between the optical parts along the optical axis is optimized, then a semiconductor light-source chip and an optical lens can be aligned with one another at least in terms of the direction of the optical axis and in the height direction.

Furthermore, each optical part is abutted against the second side surfaces, whereby the optical parts are aligned with one another in the direction substantially parallel to the surface of the substrate as well as in the direction of the optical axis. In this case, if these side surfaces of the groove with which the corresponding optical part is brought into abutting contact are adjusted in advance in such a manner that the optical axes of the optical parts will coincide with the horizontal direction, then the optical axes of a semiconductor light-source chip and optical lens can be aligned with each other in simple fashion in all directions without using a mounting apparatus having a high alignment accuracy.

Further, the guide grooves are formed by etching the substrate chemically or physically or chemically and physically. More specifically, the guide grooves can be formed highly precisely by utilizing highly accurate wet etching or dry etching that is used in working a semiconductor device. In particular, it is possible to form guide grooves of the above-described shape simply and accurately by chemically etching a silicon substrate having a surface exhibiting (110) surface orientation. Thus, in accordance with the method of manufacturing an optical semiconductor device according to the present invention, optical parts, especially a semiconductor light-source chip and optical lens, can have their optical axes aligned with one another highly accurately in all directions by simple working of the substrate on which the optical parts are mounted without using a mounting apparatus having a high alignment accuracy.

The meritorious effects of the present invention are summarized as follows.

The present invention has a number of effects and advantages. Specifically, in accordance with the structure of the optical semiconductor device of the present invention, a substrate on which optical parts are mounted has a plurality of guide grooves, each guide groove has first side surfaces substantially orthogonal to the direction of the optical axes, second side surfaces substantially parallel to the direction of the optical axes and substantially perpendicular to the surface of the substrate, and a bottom surface substantially parallel to the surface of the substrate, and each guide groove has a size and a depth that allow at least a bottom portion of the corresponding optical part to be received therein.

Accordingly, by accommodating the optical parts, particularly a semiconductor light-source chip having the shape of a rectangular parallelepiped and an optical lens member having the shape of a rectangular parallelepiped, in the guide grooves and bringing them into abutting contact with side surfaces of the guide grooves, the optical axes of the semiconductor light-source chip and optical lens can be brought into highly precise alignment.

Further, in accordance with the implementation of the method of manufacturing an optical semiconductor device according to the present invention, guide grooves having the above-described shape are formed, and optical parts, particularly a semiconductor light-source chip having the shape of a rectangular parallelepiped and an optical lens member having the shape of a rectangular parallelepiped, are brought into abutting contact with the first side surfaces of the corresponding guide grooves or, alternatively, are brought into contact with the first side surfaces and, in addition, the second side surfaces of the corresponding guide grooves, whereby the optical parts are aligned with one another in the direction of the optical axis.

In this case, by forming the guide grooves of the aforesaid shape by etching the substrate chemically, physically or chemically and physically, the guide grooves having the aforesaid shape can be formed in highly accurate fashion by simple working of the substrate on which the optical parts are mounted. As a result, by merely accommodating the optical parts, particularly a semiconductor light-source chip having the shape of a rectangular parallelepiped and an optical lens member having the shape of a rectangular parallelepiped, in the guide grooves and bringing them into abutting contact with side surfaces of the guide grooves, the optical axes of the semiconductor light-source chip and optical lens can be brought into highly precise alignment without using a mounting apparatus having a high alignment accuracy.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1A is a plan view illustrating the structure of an optical semiconductor device in a first embodiment of the present invention and useful in describing a method of manufacturing an optical semiconductor device according to a second embodiment;

FIG. 1B is a sectional taken along the optical axis of FIG. 1A;

FIG. 2A is a plan view illustrating the structure of an optical semiconductor device in another embodiment of the present invention;

FIG. 2B is a sectional taken along the optical axis of FIG. 2A;

FIG. 3A is a plan view illustrating the structure of an optical semiconductor device according to an example of the prior art and useful in describing a method of manufacturing the optical semiconductor device according to this example of prior art; and

FIG. 3B is a sectional taken along the optical axis of FIG. 3A.

### PREFERRED EMBODIMENTS OF THE INVENTION

Preferred embodiments of the present invention will now be described with reference to the drawings.

[First Embodiment]

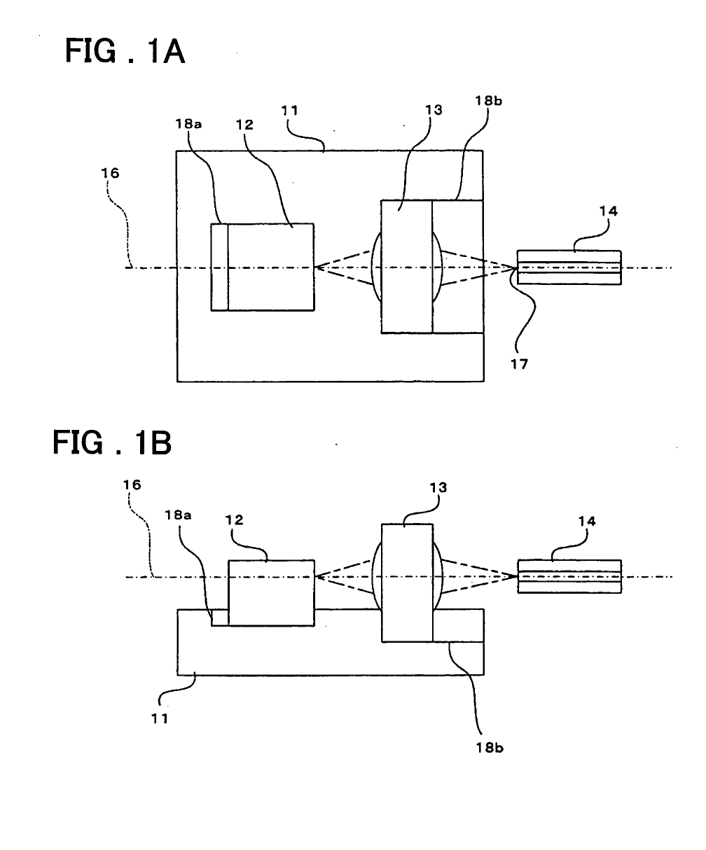

FIGS. 1A and 1B are diagrams illustrating the structure of an optical semiconductor device according to a first embodiment of the present invention, in which FIG. 1A is a plan view and FIG. 1B a sectional view taken along an optical axis 16 in FIG. 1A.

As shown in FIGS. 1A and 1B, the optical semiconductor device comprises a substrate 11 and a plurality of optical parts.

A silicon substrate having a surface with (110) surface orientation is used as the substrate 11, and a semiconductor laser chip (semiconductor light-source chip) 12 having the shape of a rectangular parallelepiped, an optical lens member 13 having the shape of a rectangular parallelepiped and an optical fiber 14 are provided as the optical parts. These optical parts are aligned with one another in terms of the optical axis 16 and are optically coupled.

Among these optical parts, the semiconductor laser chip 12 and optical lens member 13 are mounted on the substrate 11.

A plurality of guide grooves 18a, 18b are formed in the substrate 11 at the mounting positions of the optical parts. Each of the guide grooves 18a, 18b has first side surfaces, which are substantially orthogonal to the direction of the optical axis 16, second side surfaces, which are substantially parallel to the direction of the optical axis 16 and substantially perpendicular to the surface of the substrate 11, and a bottom surface substantially parallel to the surface of the substrate 11. Each of the guide grooves 18a, 18b may be just large enough to exactly accommodate the bottom portion of the corresponding optical part or may be sized to have some latitude in at least one of two directions, namely the direction orthogonal to the direction of the optical axis 16 and the direction parallel to the direction of the optical axis 16, so that the optical part is capable of being moved along this direction. In this embodiment, each guide groove has a size just large enough to exactly accommodate the corresponding optical part in the direction orthogonal to the direction of the optical axis 16, while the groove has a size provided with some latitude in at least one of the surfaces extending parallel to the direction of the optical axis 16 so that the optical part can be moved along this direction.

The corresponding optical parts are fitted into the guide grooves 18a, 18b, and the bottom and side surfaces of the optical parts, which have the shape of a rectangular parallelepiped, are brought into abutting contact with the bottom surface and side surfaces of the guide grooves 18a, 18b, whereby the optical parts have their optical axes aligned with each other.

More specifically, by fitting the optical parts into the corresponding guide grooves 18a, 18b, the optical parts abut against the bottom surfaces of the guide grooves 18a, 18b. As a result, by adjusting the depths of the guide grooves 18a, 18b in conformity with the corresponding optical parts, alignment of the optical axis 16 is performed relative to the direction substantially perpendicular to the surface of the substrate 11.

Further, by bringing the optical parts into abutting contact with either of the two first side surfaces of the guide grooves 18a, 18b that are orthogonal to the direction of the optical axis 16, the optical parts become aligned with each other in the direction of the optical axis 16. For example, each optical part is abutted against whichever of the two first side surfaces of guide groove 18a or 18b is nearer the other guide groove 18a or 18b. In this case, if the side surface against which the optical part is abutted is adjusted in advance so as to optimize the distance between the optical parts along the direction of the optical axis 16, then the optimum distance between the optical parts will be maintained by bringing the optical parts into abutting contact with respective ones of the side surfaces.

Furthermore, by abutting each optical part against either of the two second side surfaces that are parallel to the direction of the optical axis and substantially perpendicular to the surface of the substrate 11, the optical parts can be aligned with each other in the direction substantially parallel to the surface of the substrate 11. For example, of the two second side surfaces of the guide grooves 18a, 18b that are parallel to the direction of the optical axis 16 and substantially perpendicular to the surface of the substrate 11, each optical part is abutted against the respective side surface that is illustrated as the upper side in the drawings. In this case, if the side surface against which the optical part is abutted is adjusted in advance in such a manner that the optical axis 16 of the optical parts will coincide with the horizontal direction, then alignment of the optical axis 16 is performed relative to the direction substantially parallel to the surface of the substrate 11.

Thus, the optical axes 16 of the optical parts will coincide relative to the directions substantially parallel and substantially perpendicular to the surface of the substrate 11.

It should be noted that the optical fiber 14 is not mounted on the silicon substrate 11 but is disposed on another substrate or the like (not shown) neighboring the silicon substrate 11. However, by mounting the optical lens member 13 on the silicon substrate 11 in the manner described above, optical coupling between the optical lens member 13 and the optical fiber 14 is achieved.

Thus, in accordance with the optical semiconductor device of the first embodiment of the present invention, the substrate 11 on which the optical parts are mounted has the plurality of guide grooves 18a, 18b, each of the guide grooves 18a, 18b has first side surfaces, which are substantially orthogonal to the direction of the optical axis 16, side surfaces, which are substantially parallel to the direction of the optical axis 16 and substantially perpendicular to the surface of the substrate 11, and a bottom surface substantially parallel to the surface of the substrate 11. Each of the guide grooves 18a, 18b has a size and a depth that will allow at least the bottom portion of the corresponding optical part to be received in the guide groove.

Accordingly, by accommodating the semiconductor laser chip 12 and optical lens member 13, which have the shape of a rectangular parallelepiped, in the guide grooves 18a, 18b, respectively, and bringing these optical parts into abutting contact with bottom and side surfaces of the guide grooves 18a, 18b, the alignment of the optical axis 16 between the optical parts, especially the semiconductor laser chip 12 and optical lens member 13, can be performed in all directions without using a mounting apparatus having a high alignment accuracy.

[Second Embodiment]

A method of manufacturing the above-described optical semiconductor device according to a second embodiment of the present invention will now be described.

First, a silicon substrate having a surface with (110) surface orientation is prepared as the substrate 11. Next, the guide grooves 18a, 18b for accommodating the semiconductor laser chip 12 and optical lens member 13 each having the shape of a rectangular parallelepiped, respectively, are formed in the substrate 11 at the mounting positions of these optical parts.

The guide grooves 18a, 18b formed each have first side surfaces orthogonal to the direction of the optical axis 16, second side surfaces parallel to the direction of the optical axis 16 and substantially perpendicular to the surface of the substrate 11, and a bottom surface substantially parallel to the surface of the substrate 11. Each guide groove has a size and a depth that allow at least a bottom portion of the corresponding optical part to be received therein. In this embodiment, each of the guide grooves 18a, 18b is such that the width thereof in the direction orthogonal to the direction of the optical axis 16 is made just large enough to exactly accommodate the corresponding optical part, and such that the width thereof parallel to the direction of the optical axis 16 is made larger than the width of the bottom portion of the corresponding optical part.

In order to form the guide grooves 18a, 18b thus shaped, the silicon substrate 11 is etched selectively based upon a mask using photolithography and dry or wet etching employed in working a semiconductor device. In case of dry etching, argon gas or other well-known gas, for example, is used as the etching gas and etching is performed chemically, physically or chemically and physically. In case of wet etching, a strong alkali such as potassium hydroxide or other well-known compound is used as the etchant and etching is performed chemically. As a result, in accordance with the (110) surface orientation of the silicon substrate 11, the guide grooves 18a, 18b having substantially vertical side surfaces can be formed.

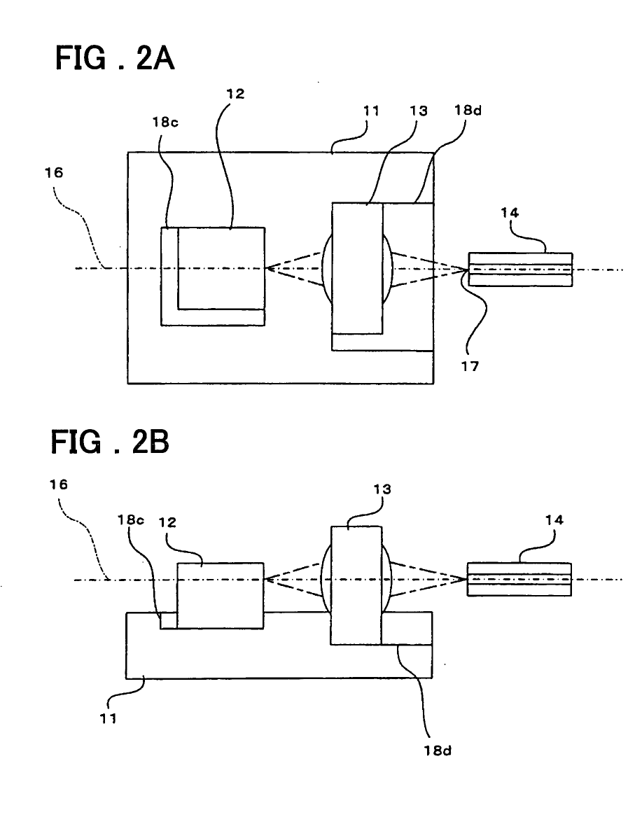

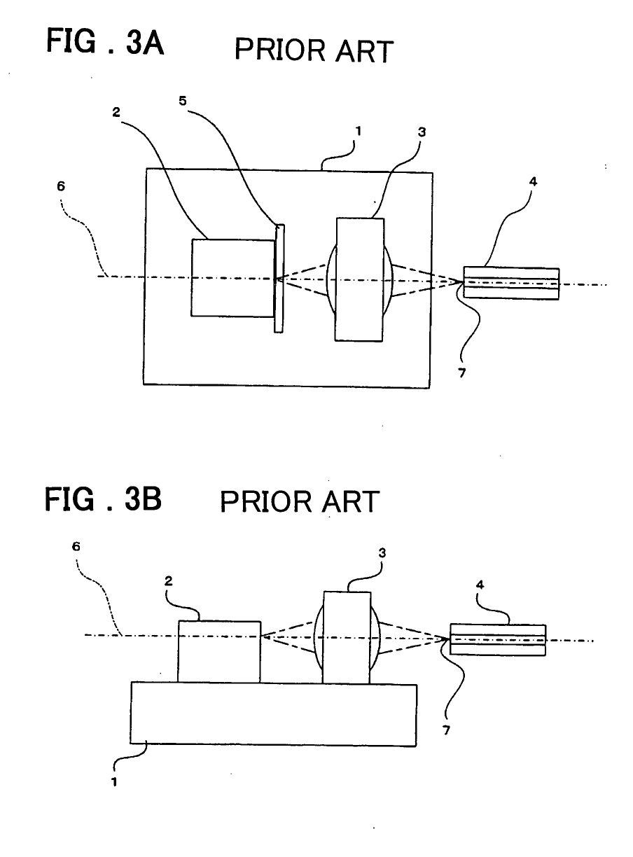

In this case, the semiconductor laser chip 12 and the optical lens member 13 in the shape of the rectangular parallelepiped generally have different heights from the bottom surface to the optical axis 16 and therefore etching is performed separately for each so as to make the depths of the guide grooves 18a, 18b conform to the optical parts mounted. A resist mask or a silicon-containing insulating film having openings and formed on the silicon substrate 11 can be used as the mask for selective etching. If a resist mask is used, the resist mask is formed twice and the silicon substrate 11 is etched using each of these resist masks separately to form the guide grooves 18a, 18b having different depths. If use is made of a silicon-containing insulating film having openings, first the silicon-containing insulating film is formed on the silicon substrate 11 by the well-known thermal oxidation method or CVD method. Next, after the resist mask is formed on the silicon-containing insulating film, openings corresponding to all of the guide grooves 18a, 18b are formed in the silicon-containing insulating film. This is followed by etching the silicon substrate 11 twice through the openings in the silicon-containing insulating film, thereby forming the guide grooves 18a, 18b having different depths. Since the guide grooves 18a, 18b thus formed are the result of using photolithography and dry or wet etching employed in the working of semiconductor devices, the guide grooves exhibit a high degree of working precision on the micron order. More specifically, working precision is 3 μm. Hence the relative positions of the semiconductor laser chip 12 and optical lens member 13 will experience a deviation of only 6 μm at most in comparison with the design value even in the worst case. This value is one-tenth of that in the case of the prior art shown in FIGS. 2A, 2B and indicates that working precision is greatly improved.

Next, by bringing the optical parts into abutting contact with either one of the two first side surfaces, namely the side surfaces that are orthogonal to the direction of the optical axis 16, of the guide grooves 18a, 18b, the optical axes of the optical parts are aligned with each other in the direction of the optical axis 16. For example, each optical part is abutted against whichever of the two first side surfaces of guide groove 18a or 18b is nearer the other guide groove 18a or 18b. As a result, the optimum distance between the optical parts is maintained.

Furthermore, by abutting each optical part against either of the two second side surfaces, namely the side surfaces that are parallel to the direction of the optical axis and substantially perpendicular to the surface of the substrate 11, the optical parts can be aligned with each other relative to the direction substantially parallel to the surface of the substrate 11. For example, of the two second side surfaces of the guide grooves 18a, 18b that are parallel to the direction of the optical axis 16 and substantially perpendicular to the surface of the substrate 11, each optical part is abutted against the respective side surface that is illustrated as the upper side in the drawings. On the hand, by accommodating the optical parts in the corresponding guide grooves 18a, 18b, the optical parts come into abutting contact with the bottom surfaces of the guide grooves 18a, 18b. Since the depths of the guide grooves 18a, 18b have been adjusted to conform to the corresponding optical parts, the parts will be aligned with each other relative to the direction perpendicular to the surface of the substrate 11. Thus, owing to this alignment in the direction substantially parallel to the surface of the substrate 11 and in the direction substantially perpendicular to the surface of the substrate 11, the optical parts coincide with each other in terms of the optical axis 16.

The optical fiber 14 is not mounted on the substrate 11 but is disposed adjacent the silicon substrate 11. However, by mounting the optical lens member 13 on the silicon substrate 11 in the manner mentioned above, the optical lens member 13 and the optical fiber 14 can be optically coupled.

With the optical semiconductor device produced as described above, the relative positions between the semiconductor laser chip 12 and optical lens member 13 undergo a deviation of 6 μm at most in comparison with the design value even in the worst case. Owing to this deviation, a focal point 17 shown in FIG. 1 will shift by 54 μm in the direction of the optical axis 16 and by 18 μm in the direction orthogonal to the optical axis 16 if the optical lens member 13 has a magnification of 3×. These values are one-tenth those of the prior art shown in FIGS. 2A, 2B and signify that the performance of this optical semiconductor device is greatly improved.

Thus, in accordance with the method of manufacturing the optical semiconductor device of the second embodiment of the present invention, the guide grooves 18a, 18b are formed by etching the substrate 11. In this case, it is possible to form the guide grooves 18a, 18b highly accurately by utilizing highly accurate etching techniques used in the working of semiconductor devices. Furthermore, by anisotropically etching the silicon substrate 11 having a surface with (110) surface orientation, the guide grooves 18a, 18b having the above-described shape can be formed simply and accurately.

Thus, in accordance with the method of manufacturing the optical semiconductor device according to this embodiment of the present invention, the optical parts, especially the semiconductor laser chip 12 and optical lens member 13, can be aligned with each other highly accurately in all directions by simple working of the substrate on which the optical parts are mounted, and this can be achieved without using a mounting apparatus having a high degree of alignment precision.

Though the embodiments have been described in detail with reference to the drawings, the structure of the invention is not limited to these embodiments and the invention can be modified without departing from the gist of the invention.

By way of example, in the embodiments set forth above, the widths of the guide grooves 18a, 18b are sized in the direction orthogonal to the optical axis 16 so that the optical parts will just fit but have some latitude in the direction parallel to the optical axis 16. However, a converse arrangement may be adopted, in which the widths of the guide grooves 18a, 18b are sized in the direction parallel to the optical axis 16 so that the optical parts will just fit but have some latitude in the direction orthogonal to the optical axis 16, or it may be so arranged that the widths are sized in both of these directions so that the optical parts will just fit. Further, as shown in FIGS. 2A, 2B illustrating another embodiment, the widths of the guide grooves 18a, 18b may be provided with some latitude in both the direction orthogonal to the direction of the optical axis 16 and the direction parallel to the direction of the optical axis 16.

Though a silicon substrate with (110) surface orientation is used as the substrate 11, this does not impose a limitation upon the invention.

Further, each of the guide grooves 18a, 18b has a planar shape that is rectangular, though this does not impose a limitation upon the invention. It will suffice if each groove is shaped to have a bottom surface and at least one side surface against which the corresponding optical part can be abutted.

The present invention is applicable widely to optical semiconductor devices, and to methods of manufacturing the same, in which a plurality of optical parts are mounted on a substrate and optically coupled.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. An optical semiconductor device comprising a substrate and a plurality of optical parts mounted on said substrate and optically coupled with their optical axes in alignment with one another;
wherein a plurality of guide grooves are formed in said substrate at mounting positions of respective ones of the plurality of optical parts, each guide groove has at least a first side surface substantially orthogonal to the direction of the optical axis, second side surfaces substantially parallel to the direction of the optical axis and substantially perpendicular to the surface of said substrate, and a bottom surface substantially parallel to the surface of said substrate, each guide groove having a size and a depth that allow at least a bottom portion of the corresponding optical part to be received therein; and
in each guide groove the corresponding optical part is accommodated in abutting contact with said first side surface of the guide groove, whereby the optical parts are aligned with one another along the direction of the optical axis.

2. The device according to claim 1, wherein each optical part is abutted against said second side surface, whereby the optical parts are aligned with one another along the direction substantially parallel to the surface of the substrate as well as along the direction of the optical axis.

3. The device according to claim 1, wherein said substrate is a silicon substrate with (110) surface orientation.

4. The device according to claim 1, wherein said optical parts are a semiconductor light-source chip and an optical lens in the shape of a rectangular parallelepiped.

5. The device according to claim 2, wherein said optical parts are a semiconductor light-source chip and an optical lens in the shape of a rectangular parallelepiped.

6. A method of manufacturing an optical semiconductor device having a substrate and a plurality of optical parts mounted on the substrate and optically coupled with their optical axes in alignment with one another, the method comprising the steps of:
forming a plurality of guide grooves in the substrate at mounting positions of respective ones of the plurality of optical parts, each guide groove having at least a first side surface substantially orthogonal to the direction of the optical axis, second side surfaces substantially parallel to the direction of the optical axis and substantially perpendicular to the surface of the substrate, and a bottom surface substantially parallel to the surface of the substrate, each guide groove having a size and a depth that allow at least a bottom portion of the corresponding optical part to be received therein; and
accommodating each optical part in a corresponding one of the guide grooves in abutting contact with the first side surface of the guide groove, whereby the optical parts are aligned with one another along the direction of the optical axis.

7. The method according to claim 6, further comprising a step of abutting each optical part against the second side surface, whereby the optical parts are aligned with one another along the direction substantially parallel to the surface of the substrate as well as along the direction of the optical axis.

8. The method according to claim 6, wherein the substrate is a silicon substrate with (110) surface orientation.

9. The method according to claim 8, wherein the guide grooves are formed by etching the substrate chemically or physically or chemically and physically.

10. The method according to claim 6, wherein the optical parts are a semiconductor light-source chip and an optical lens in the shape of a rectangular parallelepiped.
